(19) United States
(12) Patent Application Publication
(10) Pub. No.: US 2019/0340529 A1
(43) Pub. Date: Nov. 7, 2019

(54) Automatic Digital Asset Sharing Suggestions

(71) Applicant: Apple Inc., Cupertino, CA (US)

(72) Inventors: Eric Circlaeys, Los Gatos, CA (US); Kevin Aujoulet, San Francsico, CA (US); Sabrine Rekik, San Francisco, CA (US); Chelsea J. LeBlanc, Mountain View, CA (US); Damien Coin-Perard, Santa Clara, CA (US)

(21) Appl. No.: 16/142,868

(22) Filed: Sep. 26, 2018

Related U.S. Application Data
(60) Provisional application No. 62/668,077, filed on May 7, 2018.

(51) Int. Cl. G06N 5/04; G06F 17/30

(52) U.S. Cl. CPC G06N 5/048; G06F 17/30542; G06F 17/30958; G06F 17/30867

(57) ABSTRACT

Techniques of digital asset management (DAM) are described. A DAM system can obtain a knowledge graph metadata network describing relationships between metadata associated with a user's collection of digital assets (DAs), e.g., images, videos, music, etc. Based on information obtained, e.g., from the user's DA collection and/or the knowledge graph metadata network, the DAM system may provide users with more intelligent (and automated) DA sharing suggestions that are as relevant as possible for a given context. In some embodiments, the sharing suggestions may be based on one or more DAs recently shared with the user from a third party. In other embodiments, a proactive sharing suggestion may be presented to a user based on a detected indication of an intent to share DAs, e.g., based on the extraction of relevant features from an incoming message from a third party (or an outgoing message from the user to a third party).

### CROSS-REFERENCE TO RELATED APPLICATIONS

This application claims priority to U.S. Provisional Patent Application No. 62/668,077, entitled “Automatic Digital Asset Sharing Suggestions,” filed May 7, 2018 (“the '077 Application”). This application is related to the following applications: (i) U.S. Non-Provisional patent application Ser. No. 15/391,269, entitled “Notable Moments in a Collection of Digital Assets,” filed Dec. 27, 2016 (“the '269 Application”); (ii) U.S. Non-Provisional patent application Ser. No. 15/391,276, entitled “Knowledge Graph Metadata Network Based on Notable Moments,” filed Dec. 27, 2016 (“the '276 Application”); (iii) U.S. Non-Provisional patent application Ser. No. 15/391,280, entitled “Relating Digital Assets Using Notable Moments,” filed Dec. 27, 2016 (“the '280 Application”); and (iv) U.S. Non-provisional patent application Ser. No. 14/733,663, entitled “Using Locations to Define Moments,” filed Jun. 8, 2015 (“the '663 Application”). Each of the aforementioned applications is incorporated by reference in its entirety.

### TECHNICAL FIELD

Embodiments described herein relate to digital asset management (also referred to as DAM). More particularly, embodiments described herein relate to organizing, storing, describing, and/or retrieving digital assets (also referred to herein as “DAs”), such that they may be presented to a user of a computing system in the form of suggestions to share one or more of the DAs from a collection of DAs with one or more third parties, e.g., based on contextual analysis.

### BACKGROUND

Modern consumer electronics have enabled users to create, purchase, and amass considerable amounts of digital assets, or “DAs.” For example, a computing system (e.g., a smartphone, a stationary computer system, a portable computer system, a media player, a tablet computer system, a wearable computer system or device, etc.) can store or have access to a collection of digital assets (also referred to as a DA collection) that includes hundreds or thousands of DAs (e.g., images, videos, music, etc.).

Managing a DA collection can be a resource-intensive exercise for users. For example, retrieving multiple DAs representing an important moment or event in a user's life from a sizable DA collection can require the user to sift through many irrelevant DAs. This process can be arduous and unpleasant for many users. A digital asset management (DAM) system can assist with managing a DA collection. A DAM system represents an intertwined system incorporating software, hardware, and/or other services in order to manage, store, ingest, organize, and retrieve DAs in a DA collection. An important building block for at least one commonly available DAM system is a database. Databases comprise data collections that are organized as schemas, tables, queries, reports, views, and other objects. Exemplary databases include relational databases (e.g., tabular databases, etc.), distributed databases that can be dispersed or replicated among different points in a network, and object-oriented programming databases that can be congruent with the data defined in object classes and subclasses.

However, one problem associated with using databases for digital asset management is that the DAM system can become resource-intensive to store, manage, and update. That is, substantial computational resources may be needed to manage the DAs in the DA collection (e.g., processing power for performing queries or transactions, storage memory space for storing the necessary databases, etc.). Another related problem associated with using databases is that DAM cannot easily be implemented on a computing system with limited storage capacity without managing the assets directly (e.g., a portable or personal computing system, such as a smartphone or a wearable device). Consequently, a DAM system's functionality is generally provided by a remote device (e.g., an external data store, an external server, etc.), where copies of the DAs are stored, and the results are transmitted back to the computing system having limited storage capacity.

Thus, according to some DAM embodiments, a DAM may further comprise a knowledge graph metadata network (also referred to herein as simply a “knowledge graph” or “metadata network”) associated with a collection of digital assets (i.e., a DA collection). The metadata network can comprise correlated metadata assets describing characteristics associated with digital assets in the DA collection. Each metadata asset can describe a characteristic associated with one or more digital assets (DAs) in the DA collection. For example, a metadata asset can describe a characteristic associated with multiple DAs in the DA collection, such as the location, day of week, event type, etc., of the one or more associated DAs. Each metadata asset can be represented as a node in the metadata network. A metadata asset can be correlated with at least one other metadata asset. Each correlation between metadata assets can be represented as an edge in the metadata network that is between the nodes representing the correlated metadata assets. According to some embodiments, the metadata networks may define multiple types of nodes and edges, e.g., each with their own properties, based on the needs of a given implementation.

In addition to the aforementioned difficulties that a user may face in managing a large DA collection (e.g., locating and/or retrieving multiple DAs representing an important moment or event in a user's life), users may also struggle to determine (or be unable to spend the time it would take to determine) which DAs would be meaningful to share with third parties, e.g., other users of similar DAM systems and/or social contacts of the user. Further, users may struggle to determine (or not even be cognizant of) which third parties may be interested in which DAs—and from which events in the user's life. Thus, there is a need for methods, apparatuses, computer readable media, and systems to provide users with more intelligent and automated DA sharing suggestions, e.g., based on a contextual analysis of the user's DA collection and/or the nature of the user's relationship with one or more third parties with whom the user may desire to share DAs.

### SUMMARY

Methods, apparatuses, computer-readable media, and systems for providing users with more intelligent and automated DA sharing suggestions are described herein. Such embodiments can enable the sharing of DAs from a user's DA collection in an intelligent (e.g., contextually-aware) and user-friendly (e.g., automated) fashion, while leveraging the information provided in a knowledge graph metadata network describing the user's DA collection (and/or from other informational sources) to make the DA sharing suggestions as relevant as possible for a given context—and significant/compelling enough that the user may actually decide to share the suggested DAs.

For one embodiment, a process is described that comprises obtaining a collection of metadata associated with a user's collection of DAs. In addition to obtaining information describing the collection of DAs, the process may also obtain a knowledge graph metadata network for the collection of DA. Within the DA collection, one or more unique “moments” (as will be described further below) may be identified based, at least in part, on the knowledge graph metadata network. Because each moment may be associated with one or more digital assets, the process may next determine, for at least one identified moment, one or more of the associated digital assets to suggest to share with one or more third parties. The determination of which third parties to suggest sharing with may be informed by the potential one or more third parties' relationship to the at least one identified moment (e.g., whether or not the third party appears in a DA associated with the moment, whether the third party is in a particular social group with the user, etc.). Finally, the process may provide a suggestion to the user to share the determined one or more associated digital assets with the one or more third parties. After, or in response to, receiving an indication from the user which of the determined one or more associated digital assets to share with the one or more third parties, the process may proceed to share the determined one or more associated digital assets with the one or more third parties, e.g., by sending the DAs directly with the third parties (e.g., via email, text message, instant message, or other proximity-based communications protocols, etc.), or indirectly, such as via a server holding a copy or reference to the DAs.

For another embodiment, the identification of relevant moments to share DAs from in a user's DA collection may be based on one or more DAs (and/or associated metadata) received from a third party, e.g., DAs received recently from the third party, such as in a message thread. In particular, a process may identify one or more moments within the user's DA collection to “share back” to third party based, at least in part, on the user's knowledge graph and the one or more DAs received from the third party. This identification may include analyzing the location and time metadata of the one or more DAs received from the third party and performing a search against the user's knowledge graph using the received metadata from the DAs shared by the third party. In some embodiments, the search against the user's knowledge graph may comprise a ‘fuzzy’ search that, e.g., allows for the imprecise matching of DAs in the DA collection by matching DAs that come from a larger time window and/or larger geographical region than the DAs originally shared by the third party and/or by matching DAs that are associated with moments the knowledge graph is able to infer are related to moments matching the initial search against the user's DA collection. Next, one or more of the digital assets associated with the matching moments from the user's DA collection may be determined to share back with one or more third parties. The determination of which DAs to share back may also be informed by the exact DAs originally shared by the third party and/or the third party's relationship to the at least one identified matching moment. Finally, the process may provide a suggestion to the user to share the determined one or more associated digital assets with the originally sharing third party. After, or in response to, receiving an indication from the user which of the determined one or more associated digital assets to share with the third party, the process may proceed to share the determined one or more associated digital assets with the third party.

For yet another embodiment, a process is described that comprises obtaining a collection of metadata associated with a collection of digital assets, wherein the collection of digital assets comprises one or more moments, and wherein each moment of the one or more moments is associated with one or more digital assets from the collection of digital assets. In addition to obtaining information describing the collection of DAs, the process may also obtain a knowledge graph metadata network for the collection of DA. Then, the process may receive, via a first device, an incoming message from a sender, detect a sharing intent in the incoming message, and then extract one or more features from a content of the incoming message. Based on a comparison of the one or more extracted features to the one or more moments of the collection of digital assets and the knowledge graph metadata network, the process may then determine at least one moment of the one or more moments that matches the one or more extracted features, as well as one or more of the digital assets associated with the at least one moment, to share with the sender in response to the incoming message. Finally, the process may provide a suggestion to the user, via the first device, to share the determined one or more associated digital assets with the sender. After, or in response to, receiving an indication from the user which of the determined one or more associated digital assets to share with the sender, the process may proceed to share the determined one or more associated digital assets with the sender.

Other features or advantages attributable to the embodiments described herein will be apparent from the accompanying drawings and from the detailed description that follows below.

### BRIEF DESCRIPTION OF THE DRAWINGS

Embodiments described herein are illustrated by examples and not limitations in the accompanying drawings, in which like references indicate similar features. Furthermore, in the drawings, some conventional details have been omitted, so as not to obscure the inventive concepts described herein.

FIG. 1A illustrates, in block diagram form, an asset management processing system that includes electronic components for performing digital asset management (DAM), according to an embodiment.

FIG. 1B illustrates an example of a moment-view user interface for presenting a collection of digital assets, based on the moment during which the digital assets were captured, according to an embodiment.

FIG. 2A illustrates the sharing of a plurality of DAs from a first user's DA collection to a second user, according to an embodiment.

FIG. 2B illustrates the sharing back of a plurality of DAs from a second user's DA collection to a first user, based on DAs shared by the first user, according to an embodiment.

FIG. 3 illustrates, in block diagram form, an exemplary knowledge graph metadata network, in accordance with one embodiment. The exemplary metadata network illustrated in FIG. 3 can be generated and/or used by the DAM system illustrated in FIG. 1A.

FIG. 4A illustrates, in flowchart form, an operation to provide content sharing suggestions, in accordance with an embodiment.

FIGS. 4B-4C illustrate, in flowchart form, an operation to provide contextually-aware content sharing suggestions, in accordance with an embodiment.

FIG. 5 is an exemplary user interface illustrating the provision of contextually-aware content sharing suggestions in a messaging application, in accordance with one embodiment.

FIG. 6 illustrates, in flowchart form, an operation to provide contextually-aware content sharing suggestions in a messaging application, in accordance with an embodiment.

FIG. 7 illustrates a simplified functional block diagram of an illustrative programmable electronic device for performing DAM, in accordance with an embodiment.

### DETAILED DESCRIPTION

Methods, apparatuses, computer-readable media, and systems for organizing, storing, describing, and/or retrieving digital assets (also referred to herein as “DAs”), such that they may be presented to a user of a computing system in the form of suggestions to share one or more of the DAs from a collection of DAs with one or more third parties, e.g., based on contextual analysis, are described. Such embodiments can enable digital asset management (DAM) and, in particular, the sharing of DAs from the DA collection, in a more seamless and relevant fashion.

Embodiments set forth herein can assist with improving computer functionality by enabling computing systems that use one or more embodiments of the digital asset management (DAM) systems described herein. Such computing systems can implement DAM to assist with reducing or eliminating the need for users to manually determine what, when, and who to share DAs with. This reduction or elimination can, in turn, assist with minimizing wasted computational resources (e.g., memory, processing power, computational time, etc.) that may be associated with using exclusively relational databases for DAM. For example, performing DAM via relational databases may include external data stores and/or remote servers (as well as networks, communication protocols, and other components required for communicating with external data stores and/or remote servers). In contrast, DAM performed as described herein (i.e., leveraging a knowledge graph metadata network) can occur locally on a device (e.g., a portable computing system, a wearable computing system, etc.) without the need for external data stores, remote servers, networks, communication protocols, and/or other components required for communicating with external data stores and/or remote servers. Moreover, by automating the process of content sharing suggestions in a contextually-relevant fashion, users do not have to perform as much manual examination of their (often quite large) DA collections to determine what DAs might be appropriate to share with a given third party in a given context. Consequently, at least one embodiment of DAM described herein can assist with reducing or eliminating the additional computational resources (e.g., memory, processing power, computational time, etc.) that may be associated with a user's searching, storing, and/or obtaining of DAs from external relational databases in order to determine whether or not to share such DAs with one or more third parties.

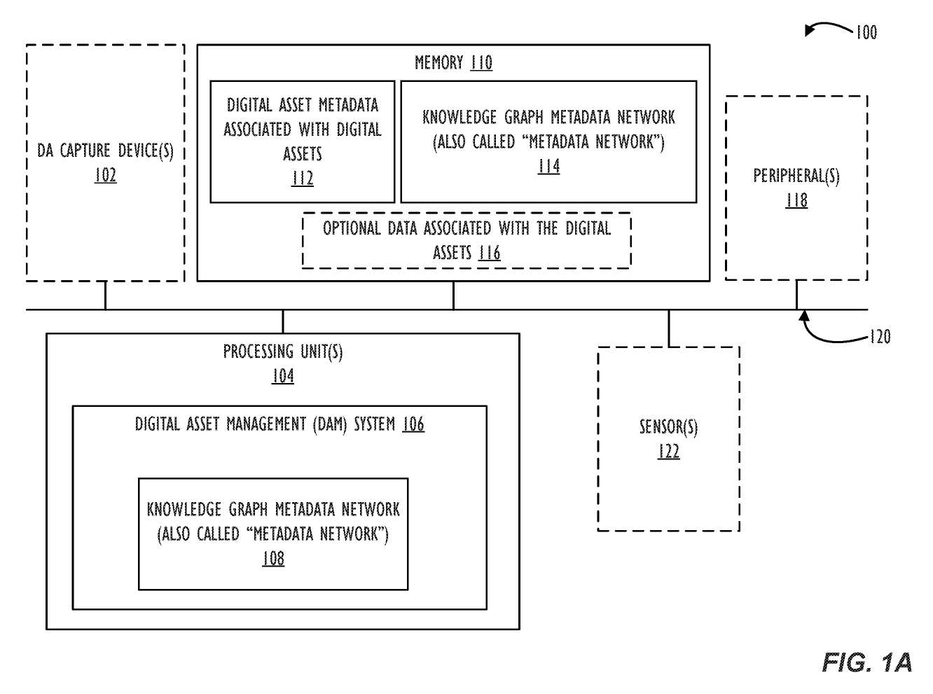

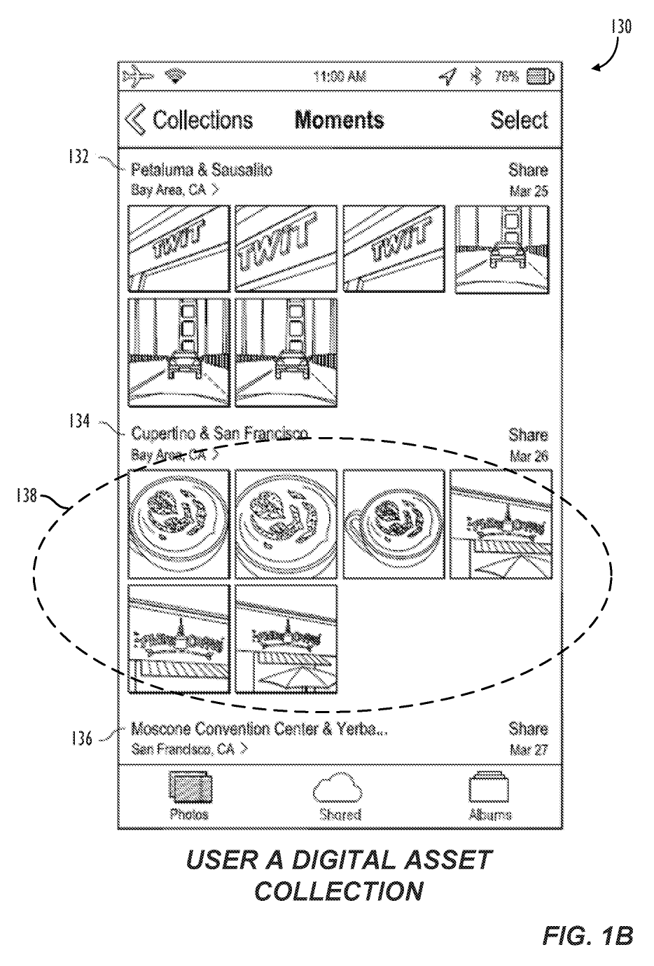

FIG. 1A illustrates, in block diagram form, a processing system 100 that includes electronic components for performing digital asset management (DAM), in accordance with one or more embodiments described in this disclosure. The system 100 can be housed in single computing system, such as a desktop computer system, a laptop computer system, a tablet computer system, a server computer system, a mobile phone, a media player, a personal digital assistant (PDA), a personal communicator, a gaming device, a network router or hub, a wireless access point (AP) or repeater, a set-top box, or a combination thereof. Components in the system 100 can be spatially separated and implemented on separate computing systems that are connected by the communication technology 110, as described in further detail below.

For one embodiment, the system 100 may include processing unit(s) 104, memory 110, a DA capture device 102, sensor(s) 122, and peripheral(s) 118. For one embodiment, one or more components in the system 100 may be implemented as one or more integrated circuits (ICs). For example, at least one of the processing unit(s) 104, the communication technology 120, the DA capture device 102, the peripheral(s) 118, the sensor(s) 122, or the memory 110 can be implemented as a system-on-a-chip (SoC) IC, a three-dimensional (3D) IC, any other known IC, or any known IC combination. For another embodiment, two or more components in the system 100 are implemented together as one or more ICs. For example, at least two of the processing unit(s) 104, the communication technology 120, the DA capture device 102, the peripheral(s) 118, the sensor(s) 122, or the memory 110 are implemented together as an SoC IC. Each component of system 100 is described below.

As shown in FIG. 1A, the system 100 can include processing unit(s) 104, such as CPUs, GPUs, other integrated circuits (ICs), memory, and/or other electronic circuitry. For one embodiment, the processing unit(s) 104 manipulate and/or process DA metadata associated with digital assets 112 or optional data 116 associated with digital assets (e.g., data objects, such as nodes, reflecting one or more persons, places, points of interest, scenes, meanings, and/or events associated with a given DA, etc.). The processing unit(s) 104 may include a digital asset management (DAM) system 106 for performing one or more embodiments of DAM, as described herein. For one embodiment, the DAM system 106 is implemented as hardware (e.g., electronic circuitry associated with the processing unit(s) 104, circuitry, dedicated logic, etc.), software (e.g., one or more instructions associated with a computer program executed by the processing unit(s) 104, software run on a general-purpose computer system or a dedicated machine, etc.), or a combination thereof.

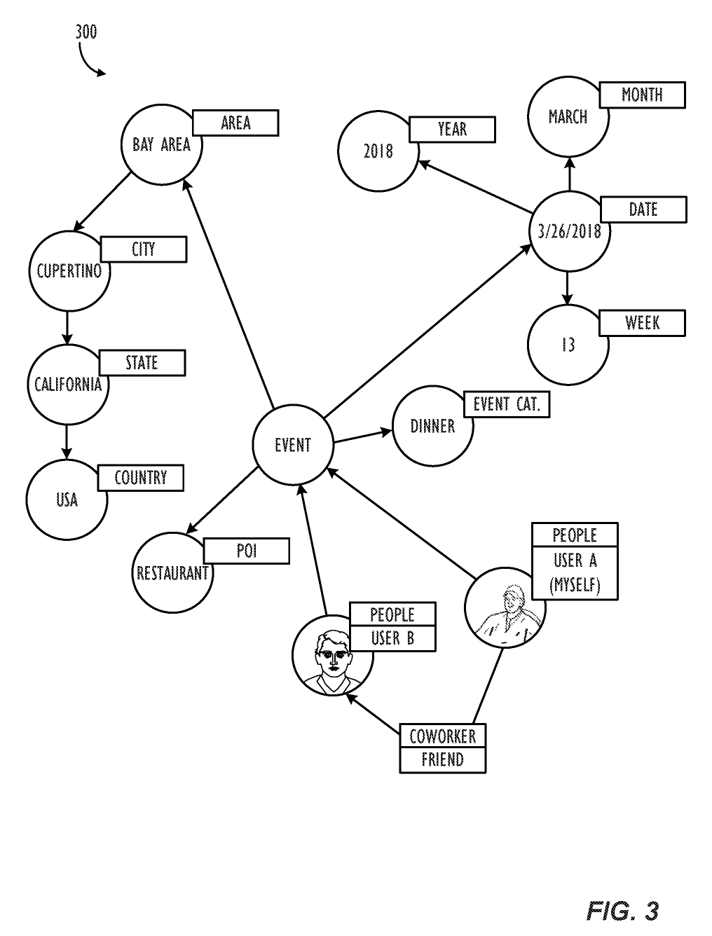

The DAM system 106 can enable the system 100 to generate and use a knowledge graph metadata network (also referred to herein more simply as “knowledge graph” or “metadata network”) 114 of the DA metadata 112 as a multidimensional network. Metadata networks and multidimensional networks that may be used to implement the various techniques described herein are described in further detail in, e.g., the '269 Application, which was incorporated by reference above. FIG. 3 (which is described below) provides additional details about an exemplary metadata network 114.

In one embodiment, the DAM system 106 can perform one or more of the following operations: (i) generate the metadata network 114; (ii) relate and/or present at least two DAs, e.g., as part of a moment, based on the metadata network 114; (iii) determine and/or present interesting DAs in the DA collection to the user as sharing suggestions, based on the metadata network 114 and one or more other criterion; and (iv) select and/or present suggested DAs to share with one or more third parties, e.g., based on a contextual analysis. Additional details about the immediately preceding operations that may be performed by the DAM system 106 are described below in connection with FIGS. 1B-6.

The DAM system 106 can obtain or receive a collection of DA metadata 112 associated with a DA collection. As used herein, a “digital asset,” a “DA,” and their variations refer to data that can be stored in or as a digital form (e.g., a digital file etc.). This digitalized data includes, but is not limited to, the following: image media (e.g., a still or animated image, etc.); audio media (e.g., a song, etc.); text media (e.g., an E-book, etc.); video media (e.g., a movie, etc.); and haptic media (e.g., vibrations or motions provided in connection with other media, etc.). The examples of digitalized data above can be combined to form multimedia (e.g., a computer animated cartoon, a video game, etc.). A single DA refers to a single instance of digitalized data (e.g., an image, a song, a movie, etc.). Multiple DAs or a group of DAs refers to multiple instances of digitalized data (e.g., multiple images, multiple songs, multiple movies, etc.). Throughout this disclosure, the use of “a DA” refers to “one or more DAs” including a single DA and a group of DAs. For brevity, the concepts set forth in this document use an operative example of a DA as one or more images. It is to be appreciated that a DA is not so limited ,and the concepts set forth in this document are applicable to other DAs (e.g., the different media described above, etc.).

As used herein, a “digital asset collection,” a “DA collection,” and their variations refer to multiple DAs that may be stored in one or more storage locations. The one or more storage locations may be spatially or logically separated as is known.

As used herein, “metadata,” “digital asset metadata,” “DA metadata,” and their variations collectively refer to information about one or more DAs. Metadata can be: (i) a single instance of information about digitalized data (e.g., a time stamp associated with one or more images, etc.); or (ii) a grouping of metadata, which refers to a group comprised of multiple instances of information about digitalized data (e.g., several time stamps associated with one or more images, etc.). There may also be many different types of metadata associated with a collection of DAs. Each type of metadata (also referred to as “metadata type”) describes one or more characteristics or attributes associated with one or more DAs. Further detail regarding the various types of metadata that may be stored in a DA collection and/or utilized in conjunction with a knowledge graph metadata network are described in further detail in, e.g., the '269 Application, which was incorporated by reference above.

As used herein, “context” and its variations refer to any or all attributes of a user's device that includes or has access to a DA collection associated with the user, such as physical, logical, social, and other contextual information. As used herein, “contextual information” and its variations refer to metadata that describes or defines a user's context or a context of a user's device that includes or has access to a DA collection associated with the user. Exemplary contextual information includes, but is not limited to, the following: a predetermined time interval; an event scheduled to occur in a predetermined time interval; a geolocation visited during a particular time interval; one or more identified persons associated with a particular time interval; an event taking place during a particular time interval, or a geolocation visited during a particular time interval; weather metadata describing weather associated with a particular period in time (e.g., rain, snow, sun, temperature, etc.); season metadata describing a season associated with the capture of one or more DAs; relationship information describing the nature of the social relationship between a user and one or more third parties; or natural language processing (NLP) information describing the nature and/or content of an interaction between a user and one more third parties. For some embodiments, the contextual information can be obtained from external sources, e.g., a social networking application, a weather application, a calendar application, an address book application, any other type of application, or from any type of data store accessible via a wired or wireless network (e.g., the Internet, a private intranet, etc.).

Referring again to FIG. 1A, for one embodiment, the DAM system 106 uses the DA metadata 112 to generate a metadata network 114. As shown in FIG. 1A, all or some of the metadata network 114 can be stored in the processing unit(s) 104 and/or the memory 110. As used herein, a “knowledge graph,” a “knowledge graph metadata network,” a “metadata network,” and their variations refer to a dynamically organized collection of metadata describing one or more DAs (e.g., one or more groups of DAs in a DA collection, one or more DAs in a DA collection, etc.) used by one or more computer systems. In a metadata network, there are no actual DAs stored—only metadata (e.g., metadata associated with one or more groups of DAs, metadata associated with one or more DAs, etc.). Metadata networks differ from databases because, in general, a metadata network enables deep connections between metadata using multiple dimensions, which can be traversed for additionally deduced correlations. This deductive reasoning generally is not feasible in a conventional relational database without loading a significant number of database tables (e.g., hundreds, thousands, etc.). As such, as alluded to above, conventional databases may require a large amount of computational resources (e.g., external data stores, remote servers, and their associated communication technologies, etc.) to perform deductive reasoning. In contrast, a metadata network may be viewed, operated, and/or stored using fewer computational resource requirements than the conventional databases described above. Furthermore, metadata networks are dynamic resources that have the capacity to learn, grow, and adapt as new information is added to them. This is unlike databases, which are useful for accessing cross-referred information. While a database can be expanded with additional information, the database remains an instrument for accessing the cross-referred information that was put into it. Metadata networks do more than access cross-referenced information—they go beyond that and involve the extrapolation of data for inferring or determining additional data. As alluded to above, the DAs themselves may be stored, e.g., on one or more servers remote to the system 100, with thumbnail versions of the DAs stored in system memory 110 and full versions of particular DAs only downloaded and/or stored to the system 100's memory 110 as needed (e.g., when the user desires to view or share a particular DA). In other embodiments, however, e.g., when the amount of onboard storage space and processing resources at the system 100 is sufficiently large and/or the size of the user's DA collection is sufficiently small, the DAs themselves may also be stored within memory 110, e.g., in a separate database, such as the aforementioned conventional databases.

The DAM system 106 may generate the metadata network 114 as a multidimensional network of the DA metadata 112. As used herein, a “multidimensional network” and its variations refer to a complex graph having multiple kinds of relationships. A multidimensional network generally includes multiple nodes and edges. For one embodiment, the nodes represent metadata, and the edges represent relationships or correlations between the metadata. Exemplary multidimensional networks include, but are not limited to, edge-labeled multigraphs, multipartite edge-labeled multigraphs, and multilayer networks.

In one embodiment, the metadata network 114 includes two types of nodes—(i) moment nodes; and (ii) non-moments nodes. As used herein, “moment” shall refer to a contextual organizational schema used to group one or more digital assets, e.g., for the purpose of displaying the group of digital assets to a user, according to inferred or explicitly-defined relatedness between such digital assets. For example, a moment may refer to a visit to coffee shop in Cupertino, Calif. that took place on Mar. 26, 2018. In this example, the moment can be used to identify one or more DAs (e.g., one image, a group of images, a video, a group of videos, a song, a group of songs, etc.) associated with the visit to the coffee shop on Mar. 26, 2018 (and not with any other moment).

As used herein, a “moment node” refers to a node in a multidimensional network that represents a moment (as is described above). As used herein, a “non-moment node” refers a node in a multidimensional network that does not represent a moment. Thus, a non-moment node may refer to a metadata asset associated with one or more DAs that is not a moment. Further details regarding the possible types of “non-moment” nodes that may be found in an exemplary metadata network may be found e.g., the '269 Application, which was incorporated by reference above.

As used herein, an “event” and its variations refer to a situation or an activity occurring at one or more locations during a specific time interval. Examples of an event may include, but are not limited to the following: a gathering of one or more persons to perform an activity (e.g., a holiday, a vacation, a birthday, a dinner, a project, a work-out session, etc.); a sporting event (e.g., an athletic competition, etc.); a ceremony (e.g., a ritual of cultural significance that is performed on a special occasion, etc.); a meeting (e.g., a gathering of individuals engaged in some common interest, etc.); a festival (e.g., a gathering to celebrate some aspect in a community, etc.); a concert (e.g., an artistic performance, etc.); a media event (e.g., an event created for publicity, etc.); and a party (e.g., a large social or recreational gathering, etc.). According to some embodiments, an event may comprise a single moment identified in a given user's DA collection. According to other embodiments, an event may comprise two or more related identified moments in a given user's DA collection.

For one embodiment, the edges in the metadata network 114 between nodes represent relationships or correlations between the nodes. For one embodiment, the DAM system 106 updates the metadata network 114 as it obtains or receives new metadata 112 and/or determines new metadata 112 for the DAs in the user's DA collection.

The DAM system 106 can manage DAs associated with the DA metadata 112 using the metadata network 114 in various ways. For a first example, DAM system 106 may use the metadata network 114 to identify and present interesting groups of one or more DAs in a DA collection based on the correlations (i.e., the edges in the metadata network 114) between the DA metadata (i.e., the nodes in the metadata network 114) and one or more criterion. For this first example, the DAM system 106 may select the interesting DAs based on moment nodes in the metadata network 114. In some embodiments, the DAM system 106 may suggest that a user shares the one or more identified DAs with one or more third parties. For a second example, the DAM system 106 may use the metadata network 114 and other contextual information gathered from the system (e.g., the user's relationship to one or more third parties, a topic of conversation in a messaging thread, an inferred intent to share DAs related to one or moments, etc.) to select and present a representative group of one or more DAs that the user may want to share with one or more third parties.

The system 100 can also include memory 110 for storing and/or retrieving metadata 112, the metadata network 114, and/or optional data 116 described by or associated with the metadata 112. The metadata 112, the metadata network 114, and/or the optional data 116 can be generated, processed, and/or captured by the other components in the system 100. For example, the metadata 112, the metadata network 114, and/or the optional data 116 may include data generated by, captured by, processed by, or associated with one or more peripherals 118, the DA capture device 102, or the processing unit(s) 104, etc. The system 100 can also include a memory controller (not shown), which includes at least one electronic circuit that manages data flowing to and/or from the memory 110. The memory controller can be a separate processing unit or integrated in processing unit(s) 104.

The system 100 can include a DA capture device 102 (e.g., an imaging device for capturing images, an audio device for capturing sounds, a multimedia device for capturing audio and video, any other known DA capture device, etc.). Device 102 is illustrated with a dashed box to show that it is an optional component of the system 100. For one embodiment, the DA capture device 102 can also include a signal processing pipeline that is implemented as hardware, software, or a combination thereof. The signal processing pipeline can perform one or more operations on data received from one or more components in the device 102. The signal processing pipeline can also provide processed data to the memory 110, the peripheral(s) 118 (as discussed further below), and/or the processing unit(s) 104.

The system 100 can also include peripheral(s) 118. For one embodiment, the peripheral(s) 118 can include at least one of the following: (i) one or more input devices that interact with or send data to one or more components in the system 100 (e.g., mouse, keyboards, etc.); (ii) one or more output devices that provide output from one or more components in the system 100 (e.g., monitors, printers, display devices, etc.); or (iii) one or more storage devices that store data in addition to the memory 110. Peripheral(s) 118 is illustrated with a dashed box to show that it is an optional component of the system 100. The peripheral(s) 118 may also refer to a single component or device that can be used both as an input and output device (e.g., a touch screen, etc.). The system 100 may include at least one peripheral control circuit (not shown) for the peripheral(s) 118. The peripheral control circuit can be a controller (e.g., a chip, an expansion card, or a stand-alone device, etc.) that interfaces with and is used to direct operation(s) performed by the peripheral(s) 118. The peripheral(s) controller can be a separate processing unit or integrated in processing unit(s) 104. The peripheral(s) 118 can also be referred to as input/output (I/O) devices 118 throughout this document.

The system 100 can also include one or more sensors 122, which are illustrated with a dashed box to show that the sensor can be optional components of the system 100. For one embodiment, the sensor(s) 122 can detect a characteristic of one or more environs. Examples of a sensor include, but are not limited to: a light sensor, an imaging sensor, an accelerometer, a sound sensor, a barometric sensor, a proximity sensor, a vibration sensor, a gyroscopic sensor, a compass, a barometer, a heat sensor, a rotation sensor, a velocity sensor, and an inclinometer.

For one embodiment, the system 100 includes communication mechanism 120. The communication mechanism 120 can be, e.g., a bus, a network, or a switch. When the technology 120 is a bus, the technology 120 is a communication system that transfers data between components in system 100, or between components in system 100 and other components associated with other systems (not shown). As a bus, the technology 120 includes all related hardware components (wire, optical fiber, etc.) and/or software, including communication protocols. For one embodiment, the technology 120 can include an internal bus and/or an external bus. Moreover, the technology 120 can include a control bus, an address bus, and/or a data bus for communications associated with the system 100. For one embodiment, the technology 120 can be a network or a switch. As a network, the technology 120 may be any network such as a local area network (LAN), a wide area network (WAN) such as the Internet, a fiber network, a storage network, or a combination thereof, wired or wireless. When the technology 120 is a network, the components in the system 100 do not have to be physically co-located. When the technology 110 is a switch (e.g., a “cross-bar” switch), separate components in system 100 may be linked directly over a network even though these components may not be physically located next to each other. For example, two or more of the processing unit(s) 104, the communication technology 120, the memory 110, the peripheral(s) 118, the sensor(s) 122, and the DA capture device 102 are in distinct physical locations from each other and are communicatively coupled via the communication technology 120, which is a network or a switch that directly links these components over a network.

FIG. 1B illustrates an example of a moment-view user interface 130 for presenting a collection of digital assets, based on the moment during which the digital assets were captured, according to an embodiment. The interface 130 includes a list view of DA collections, in this case, image collections 132, 134, and 136. Each such image collection may represent a unique moment in the user's DA collection. The image collections 132, 134, 136 include thumbnail versions of images presented with a description of the location where the images were captured and a date (or date range) during which the images were captured. The definitions and boundaries between moments can be improved using temporal data and location data to define moments more precisely and to partition moment collections into more specific moments, as is described in more detail, e.g., in the '663 Application, which was incorporated by reference above.

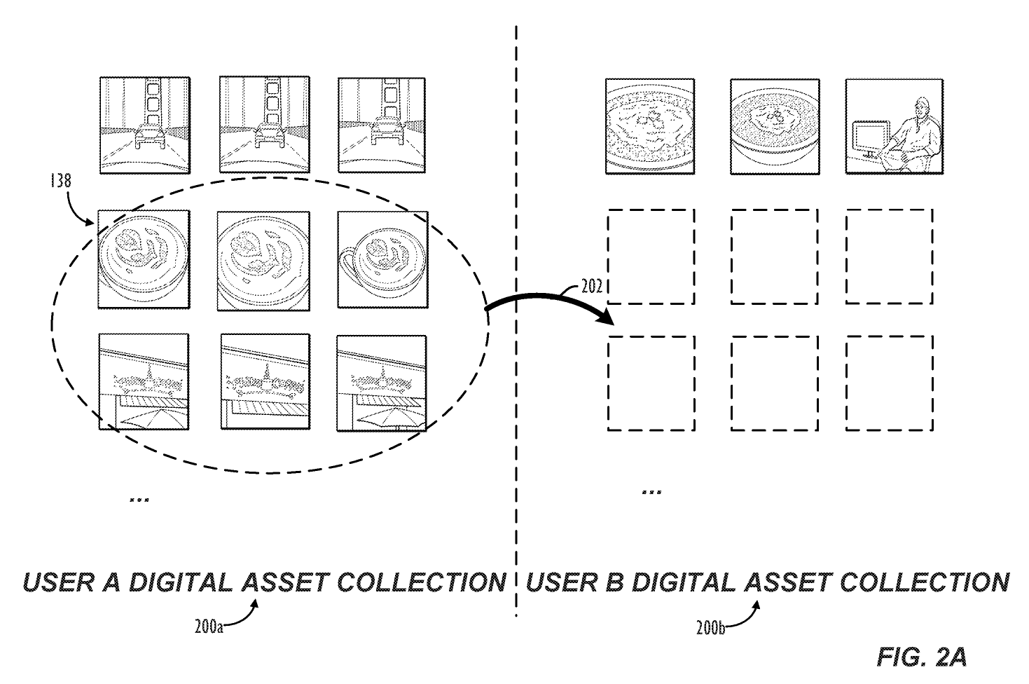

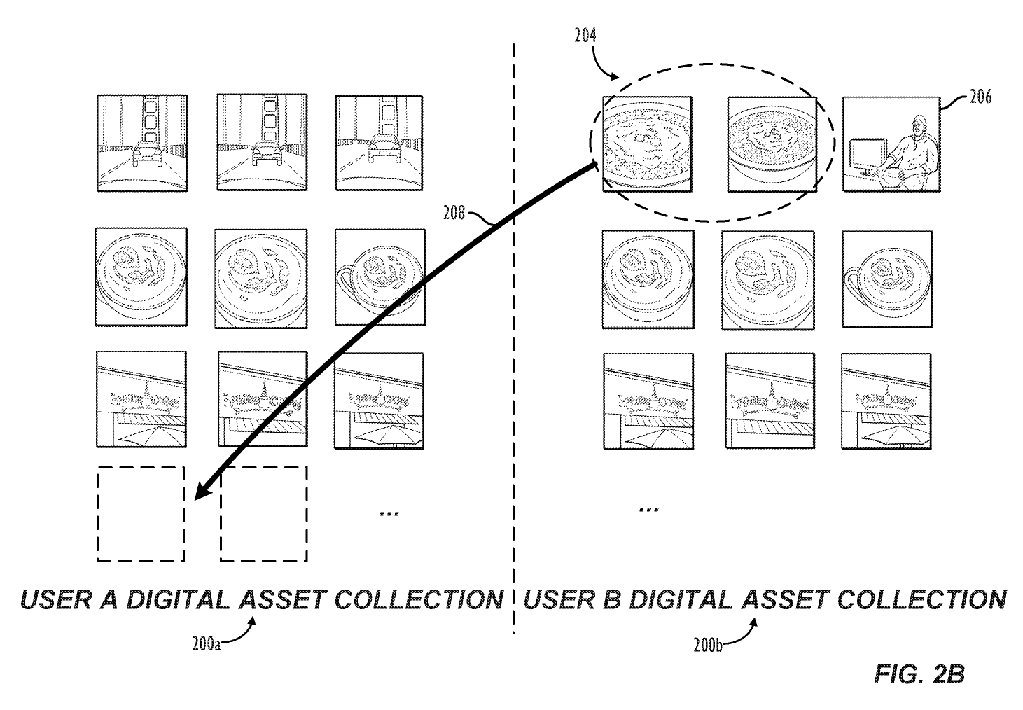

In one example, which will be described in further detail with reference to FIGS. 2A and 2B below, a certain subset of the DAs from the user's DA collection, for example DA set 138, which are part of image collection 134, and which were captured in and around Cupertino and San Francisco, Calif. on Mar. 26, 2018, may be selected by the user of the device to be shared with one or more third parties.

FIG. 2A illustrates the sharing of a plurality of DAs from a first user's DA collection to a second user, according to an embodiment. As illustrated in FIG. 2A, a first user, User A, possesses a digital asset collection 200a, which includes, among other digital assets, the various images shown in the exemplary user interface 130 of FIG. 1B. In this particular example, User A has elected to share (202) a subset of his DAs, i.e., DA set 138, with a third party, User B. As will be understood, after the sharing (202), the DAs in DA set 138 will also appear in User B's digital asset collection 200b, e.g., alongside User B's other preexisting DAs.

In some situations, the decision by User A to make the initial sharing of DA set 138 with User B may be made by manual determination. In other words, User A may remember that he went to the coffee shop with User B last week, but that User B didn't take photos of the coffee ordered by User A or the exterior of the coffee shop. As such, User A may make the manual determination that he would like to share the related set of images in DA set 138 with User B.

As will be explained in further detail below, however, according to some embodiments described herein, the suggestion of which DAs to share, with whom to share, and/or when to share such DAs may be made automatically and in an intelligent (e.g., context-aware) fashion by User A's DAM system. For example, if User A's knowledge graph indicates that User B is a close social contact of User A, the DAM may suggest sharing one or more of User A's DAs with User B, especially those DAs wherein, e.g., via DA metadata or one or more other informational sources, User A's DAM system may determine that User B was present with User A during the moment when the images in DA set 138 were captured (e.g., via User B's face being detected in one or more of the images).

In still other embodiments, as will be described in further detail below, User A's DAM system may apply contextual analysis to determine that there has been an indication of an intent to share (or a request to have shared) certain of the assets in User A's DA collection. For example, User B may have recently sent a message to User A stating, “Can you send me the photos from the coffee shop last week?” Once the sharing intent has been determined, User A's knowledge graph could quickly apply search heuristics for date ranges in the past week and points of interest such as “restaurant” or “coffee shop,” the relevant (or likely relevant) DAs that User B is requesting may be quickly identified and automatically presented to User A with a suggestion to share one or more of the matching DAs with User B. In other embodiments, the user's knowledge graph could be further leveraged to determine, e.g., proactively determine, if/when the user had DAs in his or her DA collection related to the topics being discussed (and/or the parties participating) in a messaging thread that the user may be interested in sharing with one or more third parties.

FIG. 2B illustrates yet another example of a content sharing scenario, wherein a content sharing suggestion is determined by a user's DAM system performing contextual analysis. In the example of FIG. 2B, User B's DAM system has suggested the “sharing back” (208) of a plurality of DAs 204 from User B's DA collection 200b, based on metadata associated with the DAs in DA set 138, which were shared by User A in the example of FIG. 2A described above. In particular, the identification by User B's DAM system of DAs 204 for possible “sharing back” (208) to User A may be based on identifying moments in User B's DA collection that occurred at roughly the same geographic location and/or roughly the same time interval as the DAs in User A's initial sharing of DA set 138. In some embodiments, the magnitude (e.g., in geographic scope) and/or duration (e.g., in time frame) of the suggested set of DAs to share back may scale directly and proportionally with the magnitude and duration of the initial DAs shared from the third party. Thus, as shown in FIG. 2B, the plurality of DAs 204 from User B's DA collection 200b have been suggested for a share back (208) based on the fact that they were captured on the same day and at the same coffee shop as the DAs in the initial shared DA set 138. By contrast, DA 206 in User B's DA collection represents a DA that was captured at a different location and/or during a different time interval than the DAs in the initial shared DA set 138, and thus is not a part of the exemplary suggested share back DAs 204.

FIG. 3 illustrates, in block diagram form, an exemplary knowledge graph metadata network 300, in accordance with one embodiment. The exemplary metadata network illustrated in FIG. 3 can be generated and/or used by the DAM system illustrated in FIG. 1A. For one embodiment, the metadata network 300 illustrated in FIG. 3 is similar to or the same as the metadata network 114 described above in connection with FIG. 1A. It is to be appreciated that the metadata network 300 described and shown in FIG. 3 is exemplary, and that not every type of node or edge that can be generated by the DAM system 106 is shown. For example, even though every possible node is not illustrated in FIG. 3, the DAM system 106 can generate a node to represent several of the metadata assets associated with the DA set 138 shared in the exemplary scenario illustrated in FIG. 2A.

In the metadata network 300 illustrated in FIG. 3, nodes representing metadata are illustrated as circles, and edges representing correlations between the metadata are illustrated as connections or edges between the circles. Furthermore, certain nodes are labeled with the type of metadata they represent (e.g., area, city, state, country, year, day, week month, point of interest (POI), area of interest (AOI), region of interest (ROI), people, event type, event name, event performer, event venue, business name, business category, etc.). In the example metadata network 300 illustrated in FIG. 3, an “Event” node is shown as linking together the various other metadata nodes. In some implementations, an Event may simply comprise a moment, as discussed previously herein. In other implementations, however, an Event may be thought of as a higher-level association of DAs than a moment, e.g., two or more related moments may be recognized and referred to together as an Event. In still other embodiments, e.g., where a user may have groups of DAs involving assets other than images captured at specific times and locations, an Event may refer to all DAs related a situation or an activity occurring at one or more locations over some time interval (e.g., videos recorded at a concert, digital ticket stubs from the concert, music files from the artist performing at the concert, etc.).

For one embodiment, the metadata represented in the nodes of metadata network 300 may include, but is not limited to: other metadata, such as the user's relationships with other others (e.g., family members, friends, co-workers, etc.), the user's workplaces (e.g., past workplaces, present workplaces, etc.), the user's interests (e.g., hobbies, DAs owned, DAs consumed, DAs used, etc.), places visited by the user (e.g., previous places visited by the user, places that will be visited by the user, etc.). Such metadata information can be used alone (or in conjunction with other data) to determine or infer at least one of the following: (i) vacations or trips taken by the user; days of the week (e.g., weekends, holidays, etc.); locations associated with the user; the user's social group; the types of places visited by the user (e.g., restaurants, coffee shops, etc.); categories of events (e.g., cuisine, exercise, travel, etc.); etc. The preceding examples are meant to be illustrative and not restrictive of the types of metadata information that may be captured in metadata network 300.

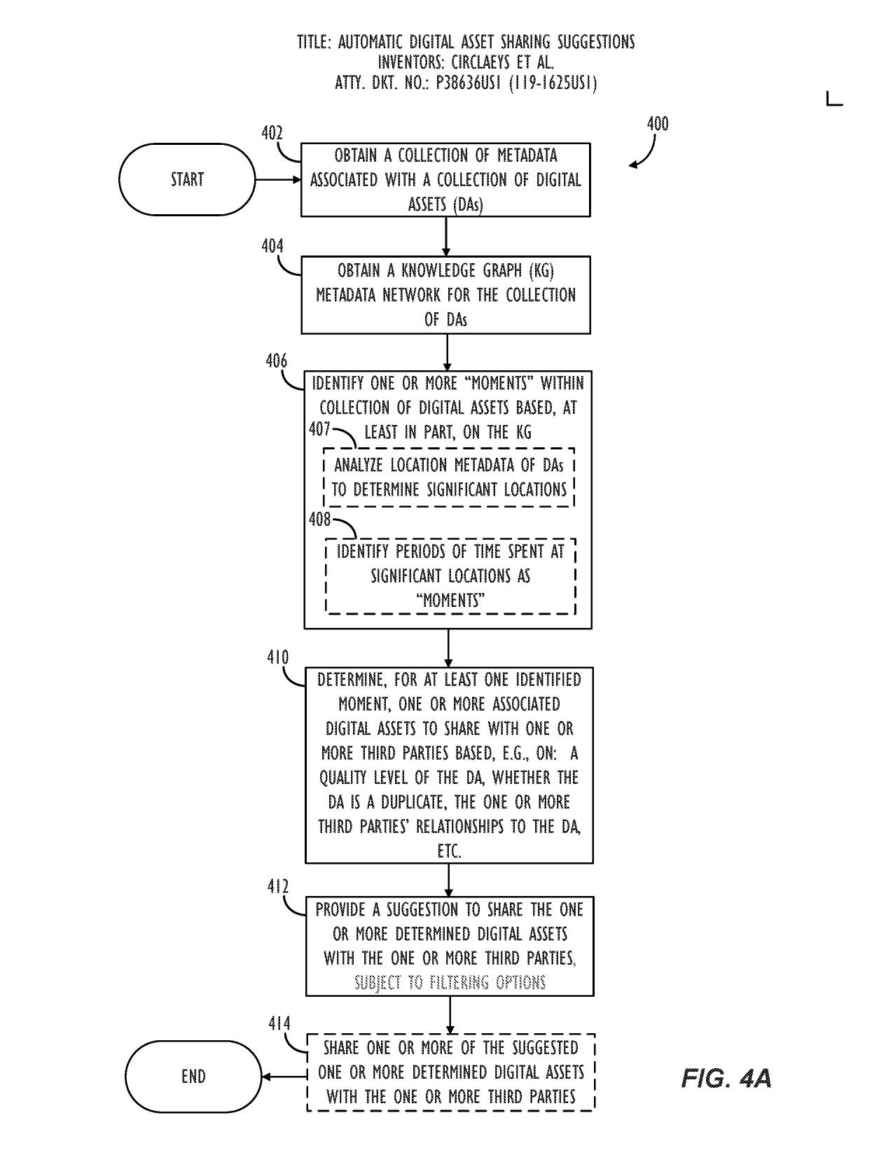

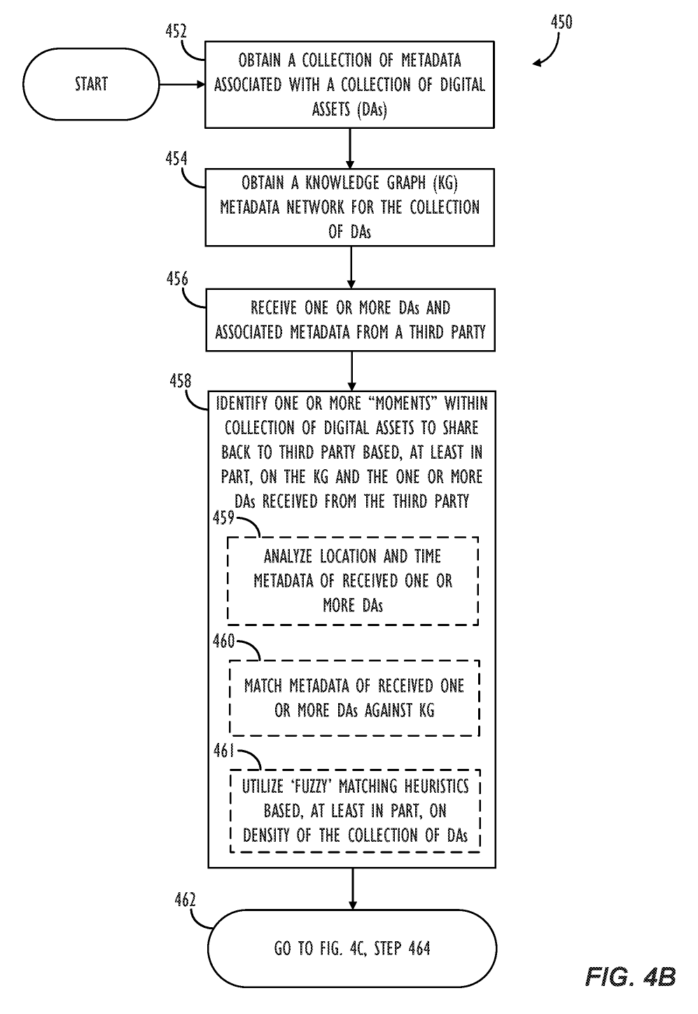

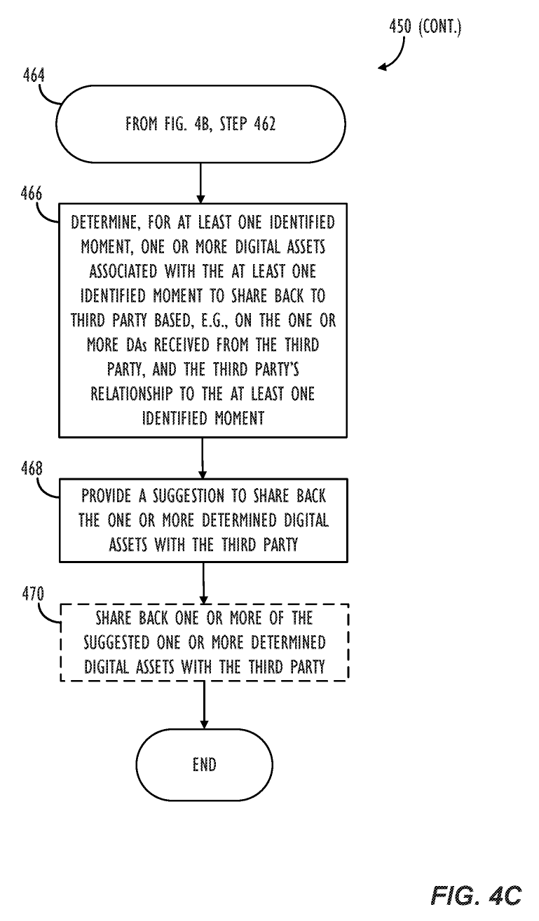

FIG. 4A illustrates, in flowchart form, an operation 400 to provide content sharing suggestions, in accordance with an embodiment. First, the operation may begin at Step 402 by obtaining a collection of metadata associated with a user's collection of DAs. Next, at Step 404, the method may also obtain a knowledge graph metadata network for the collection of DA. At Step 406, one or more unique moments may be identified within the DA collection, based, at least in part, on the knowledge graph metadata network, as described above. According to some embodiments, the identification of moments within a user's DA collection may optionally comprise analyzing at least location-related metadata of DAs in the user's DA collection to determine significant locations that the user has spent time (Step 407). In some embodiments, determining that a location is significant involves determining that the location is a location that is visited for at least a predetermined period of time or that the location is a familiar location (e.g., a user's home) or an a priori significant location (e.g., a well-known landmark). In other embodiments, determining that a location is significant may involve determining that the location is a frequently visited location for the user. Determining that a location is frequently visited can involve gathering information including location coordinates, a location name, a count indicating a number of times the electronic device visited the location, a date associated with each of the visits, a duration indication associated with each of the visits, etc. According to still other embodiments, a frequently visited place can also involve a more precise, sub-location included in the originally-identified location. Next, according to some embodiments, the moments within a user's DA collection may optionally be identified, at least in part, based on the periods of time that the user spent at significant locations (Step 408). In other words, any DAs captured or created while the user was at a particular significant location may each be tagged as being part of the same unique moment. Once the DA collection has been partitioned into moments (e.g., using any desired methodology), the identification of which one or more moments within the collection of DAs to suggest sharing content from may then be based on any of a number of factors, e.g., factors which may be gleaned from the knowledge graph. For example, a moment may be identified for suggested sharing based on one or more of the following factors: the meaning of the moment (e.g., what category of event to the DAs associated with this moment relate to), a point of interest associated with the moment, a holiday event associated with the moment, a particular location associated with the moment, a type of scene identified in the moment, a date or time associated with the moment, a particular person or group of people that are associated with a moment, whether a group of moments may be inferred to relate to one another as part of a larger event, etc.

Because each moment may be associated with one or more digital assets, the operation 400 may next determine, for at least one identified moment, one or more of the associated digital assets to suggest to share with one or more third parties (Step 410). This determination of particular associated digital assets to suggest the sharing of may be based, e.g., on selecting: only DAs above a certain quality threshold (e.g., based on focus, exposure level, saturation, color balance, user rating, a threshold number of detected faces, etc.); only DAs that are not duplicates; only DAs that are not screenshots, etc. The determination of the one or more third parties to suggest the sharing with may be informed by the one or more third parties' relationship to the at least one identified moment (e.g., whether or not the third party appears in a DA associated with the moment, whether the third party was present at the same location during the identified moment(s), whether the third party is in a particular social group with the user, etc.). In some embodiments, the one or more third parties may also be determined, at least in part, based on their current proximity to the user at the time of the sharing suggestion.

In some embodiments, the determination of the one or more third parties that the DAM suggests that the user could share the DAs with may be filtered subject to one or more filtering options. For example, in some instances, it may be desirable to filter out a third party that is otherwise determined as a suggested sharing target (e.g., based on the various factors enumerated above), but for which it may be inappropriate or undesirable to suggest to the user as sharing target.

For example, in some instances, a determined third party sharing target may be filtered out from the suggested list of recipients based on: (i) a type of person that they are; (ii) a type of scene reflected in one or more of the DAs to be shared; and/or (iii) the third party's current relationship to the user (e.g., as determined from the user's knowledge graph metadata network). For example, in some embodiments, it may be desirable to employ an age-based filtering option on the suggested sharing targets. An age-based filtering option could be used, e.g., to filter out sharing targets that are below a minimum age threshold, above a maximum age threshold, deceased, etc. In other embodiments, a filtering option may be based on whether or not the suggested sharing target is: a current social contact of the user, a blocked (or former) contact of the user, an owner of a device employing a similar DAM system to the user, or a particular type of contact of the user (e.g., a subordinate in the user's workplace, a manager in the user's workplace, a spouse/partner of the user, an ex-spouse/partner of the user, etc.). It should further be mentioned that, simply not currently existing as a social contact of the user (or not owning a device employing a similar DAM system to the user) may not necessarily be a basis for filtering out a determined third party as a suggested sharing target. For example, in some embodiments, the DAM system may provide the user an opportunity to name the third party and/or create a social contact for the third party before sharing the DAs to the third party (or, alternately, proceeding to filter out the third party as a sharing target).

In still other embodiments, e.g., as mentioned in (ii) above, the type of scene determined to be reflected in one or more DAs that are to be shared may be used to filter out suggested third party sharing targets. For example, if a certain DA is determined to represent a “pet” scene or a “nature” scene, it may be inappropriate to suggest sharing DAs with any animals whose faces may have been located within the DAs. As another example, if a certain DA represents a “child” or “baby” scene, it may be inappropriate to suggest sharing DAs with any children or babies that may be located within the DAs (as they are unlikely to be contacts or own/use a device employing a similar DAM system to the user). In some embodiments, e.g., if such information is available in the user's knowledge graph network, a parent, guardian, or other relative of a located child or baby in a DA may alternately be suggested as a third party sharing target for the DAs including representations of the child or baby (i.e., instead of the child or baby themselves).

In still other embodiments, a filtering score may be determined for each of the initially determined one or more third parties that are suggested sharing targets for the DAs, which filtering score may be used to aid the DAM in its determination of whether or not to filter out any of the determined one or more third parties as suggested sharing targets. The filtering score may be based on any desired number of filtering options for a given implementation. For example, if an initially determined third party sharing target is classified as a baby or child, that may add +100 points to their filtering score; if the initially determined third party sharing target is not a current contact of the user, that may add +50 points to their filtering score; if the initially determined third party sharing target is not a contact of the user in any external social network (or social group identified in the user's knowledge graph), that may add +25 points to their filtering score, etc. In other embodiments, e.g., a filtering option may also decrease a third party's filtering score (e.g., −25 points for each social network of the user that the third party is a contact in). In this example, the initially determined third party sharing target's filtering score may be 175 (i.e., 100+50+25). In some embodiments, a filtering score threshold may be employed, e.g., above which threshold an initially determined third party may be filtered out as a potential sharing target. For example, if a filtering score threshold in a given embodiment is 150, then the above initially determined third party having a filtering score of 175 may be filtered out from the list of sharing targets. If another third party had a filtering score below 150, then they may not be filtered out by the DAM, i.e., they may remain a suggested sharing target for the DAs.

Finally, at Step 412, the method may provide a suggestion to the user to share the determined one or more associated digital assets with the one or more third parties, e.g., subject to any third party filtering options (e.g., including the various potential filtering options described above). After, or in response to, receiving an indication from the user which of the determined one or more associated digital assets to share with the one or more third parties, the method may proceed to Step 414 and actually share one or more of the suggested one or more associated digital assets with the one or more third parties. The sharing may occur, e.g., by sending the DAs directly with the third parties (e.g., via email, text message, instant message, or other proximity-based communications protocols, etc.), or indirectly, such as via a server holding a copy or reference to the DAs. Once the desired DAs have been shared, the operation 400 may end.

FIGS. 4B-4C illustrate, in flowchart form, an operation 450 to provide contextually-aware content sharing suggestions, in accordance with an embodiment. As with other embodiments described herein, before being able to provide contextually-aware content sharing suggestions, a user's device may first obtain a collection of metadata associated with a collection of DAs (Step 452), e.g., wherein the collection of digital assets comprises one or more moments, and wherein each moment of the one or more moments is associated with one or more digital assets from the collection of digital assets. The user's device may also a priori obtain a knowledge graph metadata network for the user's collection of DAs (Step 454). Then, the operation 450 may proceed at Step 456 by receiving one or more DAs (and their associated metadata) from a third party. In the operation 450, the content sharing suggestions will be based, at least in part, on the content and/or metadata of the DAs recently shared with the user from the third party, e.g., as previously discussed with reference to FIG. 2B.

Next, at Step 458, the operation 450 may proceed to identify the relevant moments to share DAs from in a user's DA collection. This determination may be based, at least in part, on the user's knowledge graph and the one or more DAs (and/or associated metadata) received from the third party, e.g., DAs received recently from the third party, such as in a messaging thread. In particular, operation 450 may identify one or more moments within the user's DA collection to “share back” to third party, i.e., in response to the original sharing by the third party. According to some embodiments, this identification of moments to consider for the “share back” functionality may optionally include analyzing the location and time metadata of the one or more DAs received from the third party (Step 459) and performing a search against the user's knowledge graph by matching the received metadata from the DAs shared by the third party against the user's knowledge graph (Step 460). In some embodiments, the search against the user's knowledge graph may optionally comprise a ‘fuzzy’ search (Step 461), e.g., a search that allows for the imprecise matching of DAs in the DA collection by matching DAs that come from a larger time window and/or larger geographical region than the DAs originally shared by the third party. In some such embodiments, the amount of ‘fuzziness’ permitted by the search is based, at least in part, on a density of the collection of DAs. In other words, if the DA collection comprises a relatively small number of relevant DAs (i.e., is quite sparse over the relevant time period), the method may allow for much more inexact matches to the original shared DAs. By contrast, if the DA collection comprises a large number of relevant DAs (i.e., is quite dense over the relevant time period), the method may require relatively more exact matches to the original shared DAs. Fuzzy searching may also allow for a consideration of a larger set of DAs based on inferences that may be gained from the knowledge graph (e.g., including additional content from a vacation in a set of suggestions if it may be inferred that the vacation occurred over a larger time interval that was overlapping with the time window that was searched against). At Step 462, the operation 450 may continue at Step 464 of FIG. 4C.

Next, turning to FIG. 4C, at Step 466, the operation 450 may determine, for at least one of the identified moments from Step 458, one or more of the digital assets associated with the matching moments from the user's DA collection to be “shared back” with one or more third parties. Again, this determination may be based, e.g., on selecting: only DAs above a certain quality threshold (e.g., based on focus, exposure level, saturation, color balance, user rating, a threshold number of detected faces, etc.); only DAs that are not duplicates; only DAs that are not screenshots, etc. It may also be further informed by the actual DAs (and their associated metadata) that were originally shared by the third party, and/or the third party's relationship to the at least one identified matching moment. Finally, at Step 468, the operation 450 may provide a suggestion to the user to share the determined one or more associated digital assets with the originally-sharing third party. After, or in response to, receiving an indication from the user which of the determined one or more associated digital assets to share with the third party, the operation 450 may proceed to share the determined one or more associated digital assets with the third party (Step 470). According to some embodiments, the magnitude (e.g., in geographic scope) and/or duration (e.g., in time frame) of the suggested set of “share back” DAs will scale with the magnitude and duration of the initial DA share from the third party. In other words, e.g., the larger the time period (or location) over which the third party shared DAs with the user, the larger the time period (or location) over which the share back suggestion logic will consider DAs from the user's collection to be potentially matching share back DAs. Conversely, the smaller the time period (or location) over which the third party shared DAs with the user, the smaller the time period (or location) over which the share back suggestion logic will consider DAs from the user's collection to be potentially matching share back DAs.

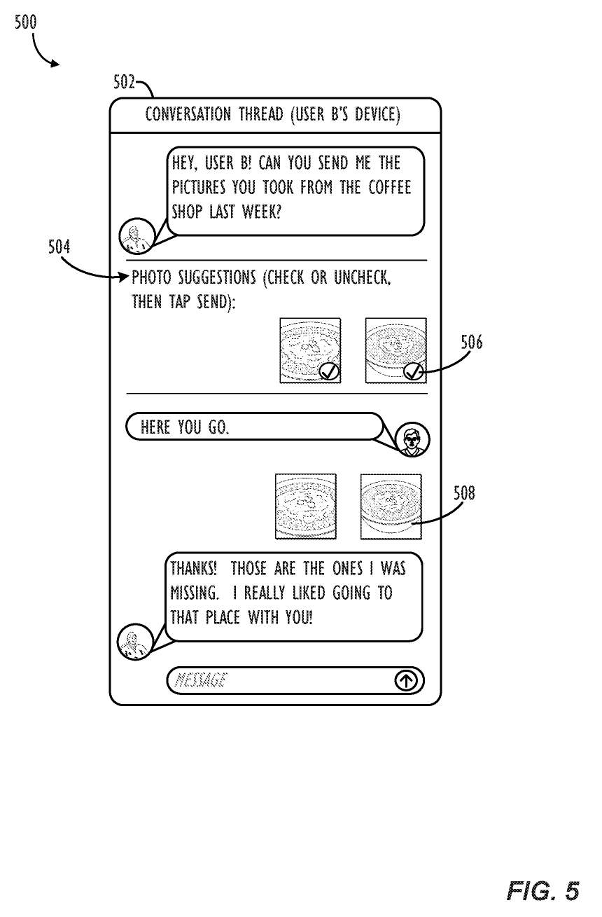

FIG. 5 is an exemplary user interface 500 illustrating the provision of a contextually-aware content sharing suggestions in a messaging application, in accordance with one embodiment. In the example of FIG. 5, the exemplary user interface 500 illustrates a conversation thread (502) occurring on User B's computing device. In this example, an initial message from User A states, “Hey, User B! Can you send me the pictures you took from the coffee shop last week?” According to some embodiments, a process may be running in the background of the messaging application to constantly analyze incoming (or outgoing) messages in the messaging application for a sharing intent, e.g., via the user of Natural Language Processing (NLP), word maps, or other Artificial Intelligence-based language processing techniques. In the example shown in FIG. 5, User B's use of the terms “send me,” “pictures,” “coffee shop,” and “last week” may, in combination, suggest to the intent determination process that User B has indicated a desire for User A to share certain DAs from User B's DA collection with him. In response to such a determination, the messaging application may display a quick suggestion (504) of the one or more DAs from User B's DA collection that it believes best match the sharing intent of the incoming message from User A. In this example, the matching DAs comprise the same two images from DA set 204, previously discussed with reference to FIG. 2B. These two images may, for example, have been taken by User B during a moment occurring during the last week, involving a location known to be a coffee shop (or other type of restaurant), and/or involving User A in some fashion (e.g., moments which include images having User A's face detected in them). It is to be understood that the quick suggestion (504) may appear only on User B's device (i.e., the owner of the DAs), and that the suggestion may appear in any desired user interface element on User B's device, e.g., in a ‘pop-up’ message box, a notification, within a messaging thread, within a message input box, etc., and that the location of the quick suggestion 504 in FIG. 5 is merely illustrative. In some embodiments, User B will then be presented with an option 506 to share all, none, or some of the automatically suggested DAs. Assuming that User B agrees to share the DAs in response to the sharing request from User A, the DAs may then be sent (508) to User A, e.g., via the same messaging application that the original incoming message from User A was received in. In other embodiments, the selected suggested DAs may be sent via some other messaging application (e.g., via email, text message, instant message, or other proximity-based communications protocols, etc.), or indirectly, such as via providing a link or reference to a location on a server holding a copy or reference to a copy of the DAs being shared.

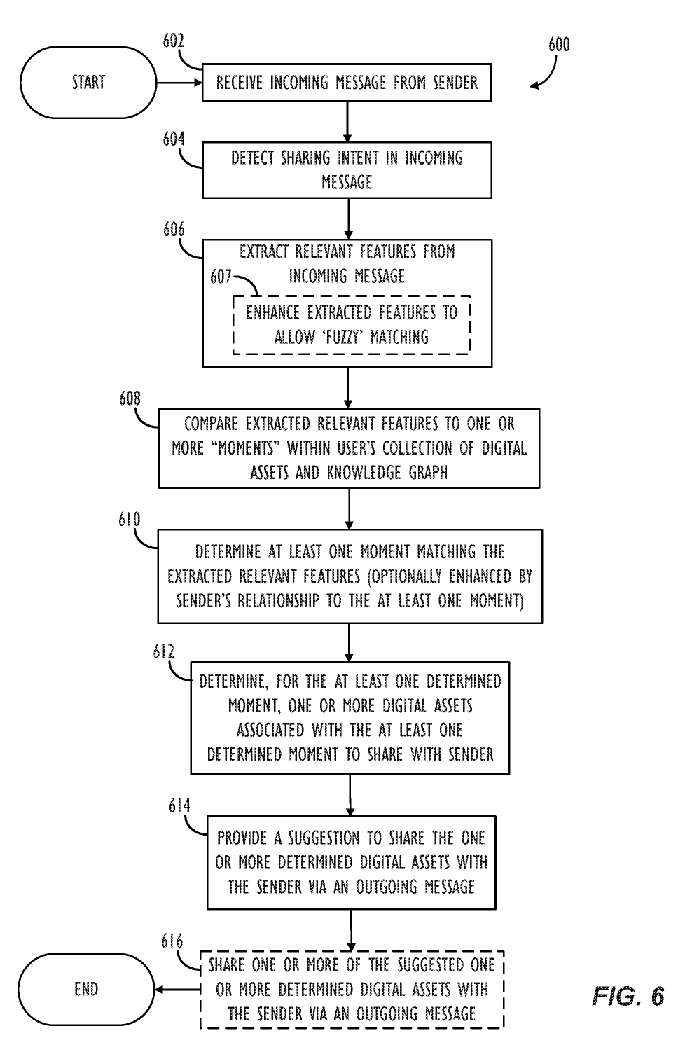

FIG. 6 illustrates, in flowchart form, an operation 600 to provide contextually-aware content sharing suggestions in a messaging application, in accordance with an embodiment. As with the other embodiments described herein, before being able to provide contextually-aware content sharing suggestions in a messaging application, a user's device may first obtain a collection of metadata associated with a collection of DAs, wherein the collection of digital assets comprises one or more moments, and wherein each moment of the one or more moments is associated with one or more digital assets from the collection of digital assets. The user's device may also a priori obtain a knowledge graph metadata network for the user's collection of DAs. Then, the operation 600 may proceed at Step 602 by receiving, e.g., at a first device of the user, an incoming message from a sender. Next, at Step 604, the DAM system on the first device may detect a sharing intent in the incoming message. According to some embodiments, determining this sharing intent from an incoming message may be achieved by performing natural language processing (NLP) on the content of the incoming message.

Next, at Step 606, the operation 600 may extract one or more features from a content of the incoming message. In some embodiments, extracting the one or more features from the content of the incoming message may further comprise enhancing the extracted features to allow for ‘fuzzy’ (i.e., inexact) matching against the user's knowledge graph. According to some embodiments, enhancing the extracted features from an incoming message may be achieved by using at least one of: synonyms of the extracted features, word embeddings based on the extracted features, and NLP on the extracted features. In some embodiments, the distance (e.g., a measure of the string difference between two character sequences) between the extracted feature(s) and the generated synonyms/embeddings may be used as an additional heuristic when attempting to perform and/or characterize the results of fuzzy searching against the user's knowledge graph.

Next, at Step 608, the operation 600 may perform a comparison of the one or more extracted features to the one or more moments identified within the user's collection of digital assets and the knowledge graph metadata network. The operation may then, at Step 610, determine at least one moment of the one or more moments that matches the one or more extracted (and optionally enhanced) features. In some embodiments, the matching of the determined at least one moment may optionally be further enhanced based, at least in part, on the sender of the message's relationship to the identified moment (e.g., whether or not the sender appears in a DA associated with the moment, whether the sender was present at the same location during the identified moment(s), whether the sender is in a particular social group with the user, etc.).

Next, at Step 612, the operation 600 may determine, for the at least one determined moment, one or more of the digital assets associated with the at least one moment, to share with the sender in response to the incoming message. For example, the operation 600 may determine that: only DAs above a certain quality threshold (e.g., based on focus, exposure level, saturation, color balance, user rating, a threshold number of detected faces, etc.); only DAs that are not duplicates; only DAs that are not screenshots; only DAs matching the detected intent of the incoming message by greater than a threshold amount, etc., should be shared with the sender.

Finally, at Step 614, the operation 600 may provide a suggestion to the user, e.g., via the first device, to share the determined one or more associated digital assets with the sender. After, or in response to, receiving an indication from the user which of the determined one or more associated digital assets to share with the sender, the operation 600 may proceed to share the determined one or more associated digital assets with the sender (Step 616). As previously mentioned, the determined one or more associated digital assets may be shared with the sender, e.g., by sending the DAs directly back to the sender via the same messaging application in which the incoming message was received, via some other messaging application (e.g., via email, text message, instant message, or other proximity-based communications protocols, etc.), or indirectly, such as via providing a link or reference to a location on a server holding a copy or reference to a copy of the DAs being shared.

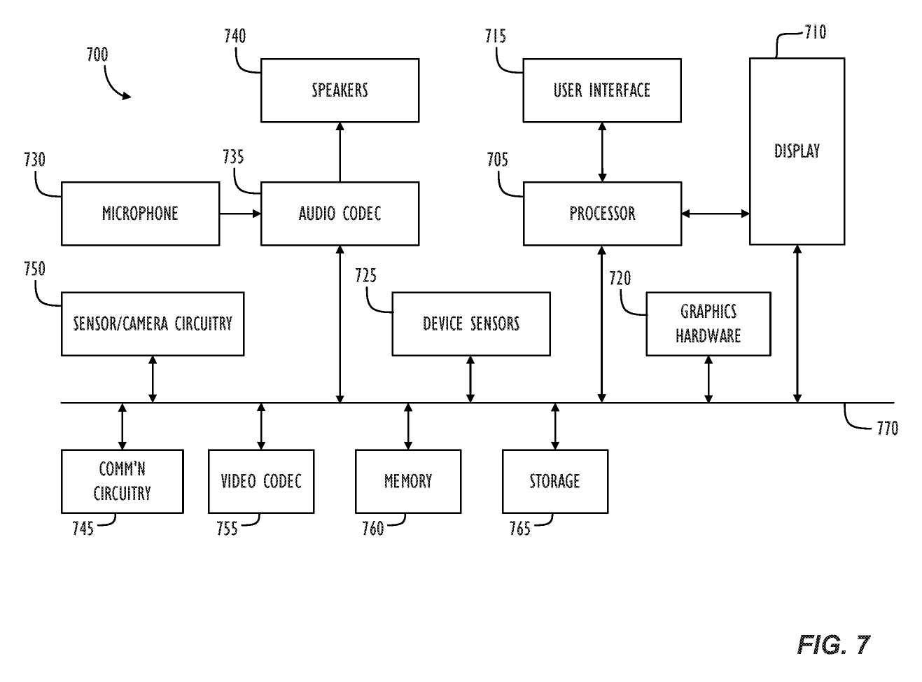

Referring now to FIG. 7, a simplified functional block diagram of an illustrative programmable electronic device 700 for performing DAM is shown, according to one embodiment. Electronic device 700 could be, for example, a mobile telephone, personal media device, portable camera, or a tablet, notebook or desktop computer system. As shown, electronic device 700 may include processor 705, display 710, user interface 715, graphics hardware 720, device sensors 725 (e.g., proximity sensor/ambient light sensor, accelerometer and/or gyroscope), microphone 730, audio codec(s) 735, speaker(s) 740, communications circuitry 745, image capture circuit or unit 750, which may, e.g., comprise multiple camera units/optical sensors having different characteristics (as well as camera units that are housed outside of, but in electronic communication with, device 700), video codec(s) 755, memory 760, storage 765, and communications bus 770.

Processor 705 may execute instructions necessary to carry out or control the operation of many functions performed by device 700 (e.g., such as the generation and/or processing of DAs in accordance with the various embodiments described herein). Processor 705 may, for instance, drive display 710 and receive user input from user interface 715. User interface 715 can take a variety of forms, such as a button, keypad, dial, a click wheel, keyboard, display screen and/or a touch screen. User interface 715 could, for example, be the conduit through which a user may view a captured video stream and/or indicate particular images(s) that the user would like to capture or share (e.g., by clicking on a physical or virtual button at the moment the desired image is being displayed on the device's display screen).

In one embodiment, display 710 may display a video stream as it is captured while processor 705 and/or graphics hardware 720 and/or image capture circuitry contemporaneously store the video stream (or individual image frames from the video stream) in memory 760 and/or storage 765. Processor 705 may be a system-on-chip such as those found in mobile devices and include one or more dedicated graphics processing units (GPUs). Processor 705 may be based on reduced instruction-set computer (RISC) or complex instruction-set computer (CISC) architectures or any other suitable architecture and may include one or more processing cores. Graphics hardware 720 may be special purpose computational hardware for processing graphics and/or assisting processor 705 perform computational tasks. In one embodiment, graphics hardware 720 may include one or more programmable graphics processing units (GPUs).

Image capture circuitry 750 may comprise one or more camera units configured to capture images, e.g., images which may be managed by a DAM system, e.g., in accordance with this disclosure. Output from image capture circuitry 750 may be processed, at least in part, by video codec(s) 755 and/or processor 705 and/or graphics hardware 720, and/or a dedicated image processing unit incorporated within circuitry 750. Images so captured may be stored in memory 760 and/or storage 765. Memory 760 may include one or more different types of media used by processor 705, graphics hardware 720, and image capture circuitry 750 to perform device functions. For example, memory 760 may include memory cache, read-only memory (ROM), and/or random access memory (RAM). Storage 765 may store media (e.g., audio, image and video files), computer program instructions or software, preference information, device profile information, and any other suitable data. Storage 765 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 760 and storage 765 may be used to retain computer program instructions or code organized into one or more modules and written in any desired computer programming language. When executed by, for example, processor 705, such computer program code may implement one or more of the methods described herein.

In the foregoing description, numerous specific details are set forth, such as specific configurations, properties, and processes, etc., in order to provide a thorough understanding of the embodiments. In other instances, well-known processes and manufacturing techniques have not been described in particular detail in order to not unnecessarily obscure the embodiments. Reference throughout this specification to “one embodiment,” “an embodiment,” “another embodiment,” “other embodiments,” “some embodiments,” and their variations means that a particular feature, structure, configuration, or characteristic described in connection with the embodiment is included in at least one embodiment. Thus, the appearances of the phrase “for one embodiment,” “for an embodiment,” “for another embodiment,” “in other embodiments,” “in some embodiments,” or their variations in various places throughout this specification are not necessarily referring to the same embodiment. Furthermore, the particular features, structures, configurations, or characteristics may be combined in any suitable manner in one or more embodiments.

In the following description and claims, the terms “coupled” and “connected,” along with their derivatives, may be used. It should be understood that these terms are not intended as synonyms for each other. “Coupled” is used herein to indicate that two or more elements or components, which may or may not be in direct physical or electrical contact with each other, co-operate or interact with each other. “Connected” is used to indicate the establishment of communication between two or more elements or components that are coupled with each other.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing system, that manipulates and transforms data represented as physical (electronic) quantities within the computer system's registers and memories into other data similarly represented as physical quantities within the computer system memories or registers or other such information storage, transmission or display devices.

Embodiments described herein can relate to an apparatus for performing a computer program (e.g., the operations described herein, etc.). Such a computer program may be stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

Although operations or methods are described above in terms of some sequential operations, it should be appreciated that some of the operations described may be performed in a different order. Moreover, some operations may be performed in parallel, rather than sequentially. Embodiments described herein are not described with reference to any particular programming language. It will be appreciated that a variety of programming languages may be used to implement the various embodiments of the disclosed subject matter. In utilizing the various aspects of the embodiments described herein, it would become apparent to one skilled in the art that combinations, modifications, or variations of the above embodiments are possible for managing components of a processing system to increase the power and performance of at least one of those components. Thus, it will be evident that various modifications may be made thereto without departing from the broader spirit and scope of at least one of the disclosed concepts set forth in the following claims. The specification and drawings are, accordingly, to be regarded in an illustrative sense, rather than a restrictive sense.

In the development of any actual implementation of one or more of the disclosed concepts (e.g., such as a software and/or hardware development project, etc.), numerous decisions must be made to achieve the developers' specific goals (e.g., compliance with system-related constraints and/or business-related constraints). These goals may vary from one implementation to another, and this variation could affect the actual implementation of one or more of the disclosed concepts set forth in the embodiments described herein. Such development efforts might be complex and time-consuming, but may still be a routine undertaking for a person having ordinary skill in the art in the design and/or implementation of one or more of the inventive concepts set forth in the embodiments described herein.

As described above, one aspect of the present technology is the gathering and use of data available from various sources to improve the delivery to users of content sharing suggestions. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content sharing suggestions that are of greater interest and/or greater contextual relevance to the user. Accordingly, use of such personal information data enables users to have more streamlined and meaningful control of the content that they share with others. Further, other uses for personal information data that benefit the user are also contemplated by the present disclosure. For instance, health and fitness data may be used to provide insights into a user's general wellness, or state of well-being during various moments or events in their lives.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of content sharing suggestion services, the present technology can be configured to allow users to select to “opt in” or “opt out” of participation in the collection of personal information data during registration for services or anytime thereafter. In another example, users can select not to provide their content and other personal information data for improved content sharing suggestion services. In yet another example, users can select to limit the length of time their personal information data is maintained by a third party, limit the length of time into the past from which content sharing suggestions may be drawn, and/or entirely prohibit the development of a knowledge graph or other metadata profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be suggested for sharing to users by inferring preferences based on non-personal information data or a bare minimum amount of personal information, such as the quality level of the content (e.g., focus, exposure levels, etc.) or the fact that certain content is being requested by a device associated with a contact of the user, other non-personal information available to the DAM system, or publicly available information.

As used in the description above and the claims below, the phrases “at least one of A, B, or C” and “one or more of A, B, or C” include A alone, B alone, C alone, a combination of A and B, a combination of B and C, a combination of A and C, and a combination of A, B, and C. That is, the phrases “at least one of A, B, or C” and “one or more of A, B, or C” means A, B, C, or any combination thereof, such that one or more of a group of elements consisting of A, B and C, and should not be interpreted as requiring at least one of each of the listed elements A, B and C, regardless of whether A, B and C are related as categories or otherwise. Furthermore, the use of the article “a” or “the” in introducing an element should not be interpreted as being exclusive of a plurality of elements. Also, the recitation of “A, B, and/or C” is equal to “at least one of A, B, or C.” Also, the use of “a” refers to “one or more” in the present disclosure. For example, “a DA” refers to “one DA” or “a group of DAs.”

What is claimed is:

1. A non-transitory computer readable medium comprising computer executable instructions stored thereon to cause one or more processors to:
obtain a collection of metadata associated with a collection of digital assets;
obtain a knowledge graph metadata network for the collection of digital assets;
identify one or more moments within the collection of digital assets based, at least in part, on the knowledge graph metadata network, wherein each moment is associated with one or more digital assets;
determine, for at least one identified moment, one or more of the associated digital assets to share with one or more third parties; and
provide a suggestion to a first user to share the determined one or more associated digital assets with the one or more third parties.

2. The non-transitory computer readable medium of claim 1, further comprising computer executable instructions stored thereon to cause the one or more processors to:
receive an indication from the first user to share the determined one or more associated digital assets with the one or more third parties; and
share the determined one or more associated digital assets with the one or more third parties.

3. The non-transitory computer readable medium of claim 2, wherein the instructions to cause the one or more processors to share the determined one or more associated digital assets with the one or more third parties further comprise instructions to cause the one or more processors to:
communicate an indication to share the determined one or more associated digital assets with the one or more third parties to a server holding a copy or reference to the determined one or more associated digital assets.

4. The non-transitory computer readable medium of claim 1, wherein the instructions to cause the one or more processors to identify one or more moments within the collection of digital assets further comprise instructions to cause the one or more processors to:
analyze location data of one or more digital assets within the collection of digital assets to determine significant locations; and
identify digital assets captured during periods of time spent at significant locations as belonging to respective moments.

5. The non-transitory computer readable medium of claim 1, wherein the instructions to cause the one or more processors to determine, for at least one moment, one or more of the associated digital assets to share with one or more third parties further comprise instructions to cause the one or more processors to:
determine the one or more third parties based, at least in part, on: the one or more third parties' relationship to the identified one or more moments; or the one or more third parties' proximity to the first user.

6. The non-transitory computer readable medium of claim 5, wherein at least one of the determined one or more third parties appears in at least one of the digital assets associated with the identified one or more moments.

7. The non-transitory computer readable medium of claim 1, wherein the instructions to cause the one or more processors to determine, for at least one moment, one or more of the associated digital assets to share with one or more third parties further comprise instructions to cause the one or more processors to:
determine the one or more third parties subject to one or more filtering options.

8. A non-transitory computer readable medium comprising computer executable instructions stored thereon to cause one or more processors to:
obtain a collection of metadata associated with a collection of digital assets;
obtain a knowledge graph metadata network for the collection of digital assets;
receive one or more first digital assets from a third party;
identify one or more moments within the collection of digital assets based, at least in part, on the knowledge graph metadata network and the one or more first digital assets received from the third party, wherein each moment is associated with one or more second digital assets;
determine, for at least one identified moment, one or more of the associated second digital assets to share with the third parties, based, at least in part, on the one or more first digital assets received from the third party; and
provide a suggestion to a first user to share the determined one or more associated second digital assets with the one or more third parties.

9. The non-transitory computer readable medium of claim 8, further comprising computer executable instructions stored thereon to cause one or more processors to:
receive an indication from the first user to share the determined one or more associated second digital assets with the one or more third parties; and
share the determined one or more associated second digital assets with the one or more third parties.

10. The non-transitory computer readable medium of claim 9, wherein the instructions to cause the one or more processors to share the determined one or more associated second digital assets with the one or more third parties further comprise instructions to cause the one or more processors to:
communicate an indication to share the determined one or more associated second digital assets with the one or more third parties to a server holding a copy or reference to the determined one or more associated second digital assets.

11. The non-transitory computer readable medium of claim 8, wherein the instructions to cause the one or more processors to identify one or more moments within the collection of digital assets further comprise instructions to cause the one or more processors to:
analyze location metadata of the one or more first digital assets;
analyze time metadata of the one or more first digital assets; and
match the location and time metadata of the one or more first digital assets to the knowledge graph metadata network.

12. The non-transitory computer readable medium of claim 11, wherein the instructions to cause the one or more processors to match the location and time metadata of the one or more first digital assets to the knowledge graph metadata network further comprise instructions to cause the one or more processors to:
perform an fuzzy search against the knowledge graph metadata network, wherein the fuzzy search allows for inexact matches with the knowledge graph metadata network.

13. The non-transitory computer readable medium of claim 12, wherein a degree to which the fuzzy search allows for inexact matches against the knowledge graph metadata network is based, at least in part, on a density of the collection of digital assets.

14. The non-transitory computer readable medium of claim 12, wherein a degree to which the fuzzy search allows for inexact matches against the knowledge graph metadata network scales proportionally with a magnitude of the analyzed location metadata.

15. The non-transitory computer readable medium of claim 12, wherein a degree to which the fuzzy search allows for inexact matches against the knowledge graph metadata network scales proportionally with a duration of the analyzed time metadata.

16. A non-transitory computer readable medium comprising computer executable instructions stored thereon to cause one or more processors to:
obtain a collection of metadata associated with a collection of digital assets, wherein the collection of digital assets comprises one or more moments, and wherein each moment of the one or more moments is associated with one or more digital assets from the collection of digital assets;
obtain a knowledge graph metadata network for the collection of digital assets;
receive, via a first device, an incoming message from a sender;
detect a sharing intent in the incoming message;
extract one or more features from a content of the incoming message;
compare the one or more extracted features to the one or more moments of the collection of digital assets and the knowledge graph metadata network;
determine based, at least in part, on the act of comparing, at least one moment of the one or more moments that matches the one or more extracted features;
determine, for the at least one determined moment, one or more of the digital assets associated with the at least one moment to share with the sender in response to the incoming message; and
provide a suggestion, via the first device, to share the determined one or more associated digital assets with the sender.

17. The non-transitory computer readable medium of claim 16, further comprising computer executable instructions stored thereon to cause one or more processors to:
receive an indication, via the first device, to share the determined one or more associated digital assets with the sender; and
send the determined one or more associated digital assets to the sender via an outgoing message.

18. The non-transitory computer readable medium of claim 17, wherein the instructions to cause the one or more processors to send the determined one or more associated digital assets to the sender via an outgoing message further comprise instructions to cause the one or more processors to:
communicate an indication to share the determined one or more associated digital assets with the sender to a server holding a copy or reference to the determined one or more associated digital assets.

19. The non-transitory computer readable medium of claim 16, wherein the instructions to cause the one or more processors to extract one or more features from the incoming message further comprise instructions to cause the one or more processors to:
enhance at least one of the one or more features using at least one of: synonyms, word embeddings, and Natural Language Processing (NLP).

20. The non-transitory computer readable medium of claim 16, wherein the instructions to cause the one or more processors to determine, for the at least one moment, one or more of the associated digital assets to share with the sender further comprise instructions to cause the one or more processors to:
determine the one or more associated digital assets based, at least in part, on the sender's relationship to the identified one or more moments.
